(19) United States
(12) Patent Application Publication
(10) Pub. No.: US 2011/0275553 A1
(43) Pub. Date: Nov. 10, 2011

(54) PROCESS OF MAKING LIQUID FABRIC SOFTENING COMPOSITIONS

(76) Inventors: Andreas Leopold, Merchtem (BE); Nilgun Esin Aksoy, Strombeek-Bever (BE); Vincenzo Tomarchio, Roma (IT)

(21) Appl. No.: 13/096,029

(22) Filed: Apr. 28, 2011

(30) Foreign Application Priority Data
May 6, 2010 (EP) 10 162 104.3

(51) Int. Cl. C11D 3/60

(52) U.S. Cl. 510/516

(57) ABSTRACT

The present invention relates to a process for making a liquid fabric softening composition, comprising the steps of;
a) Providing a first composition comprising a fabric softening active, the fabric softening active comprising a multilamellar phase of cationic vesicles;
b) Adding to, and mixing with the first composition, a silicone emulsion, and a polyol, to produce a second composition, the second composition comprising from 0.0001% to 0.1% by weight of the second composition of a water-soluble salt;
c) Adding to the second composition, a third composition, the third composition comprising, 20% to 50% by weight of the third composition of a perfume microcapsule and from 0.01% to 2.5% by weight of the third composition of a water-soluble salt;
d) Mixing the second and third compositions to make a final fabric softening composition.

### FIELD OF THE INVENTION

The present invention relates to liquid fabric softening compositions comprising silicone emulsions and perfume microcapsules, the liquid fabric softening compositions being physically stable over time.

### BACKGROUND TO THE INVENTION

Consumers expect that the laundry process will impart both excellent softness and freshness to their fabrics. Cationic fabric softening actives offer excellent softening performance. Also, often, fabric softening compositions comprise perfume ingredients, to impart a pleasing scent to the fabrics. However, free perfume ingredients do not tend to offer long lasting scent benefits to the fabrics. To overcome this, perfume delivery agents are used, such as perfume microcapsules.

Perfume microcapsules are often supplied in the form of a composition comprising the perfume microcapsules. This perfume microcapsule composition is then added to the fabric softening composition. However, often, the addition of the perfume microcapsule composition affects the long term stability of the fabric softening composition. Instability over time manifests itself as a phase separation of the fabric softening composition, wherein the two phases can not be re-mixed.

Long term stability is of importance in the shipping and storage of the fabric softening composition. Oftentimes, the fabric softening composition needs to be transported by land over large distances, often with periods of storage during the journey, such as warehouses and distribution points.

Moreover, it is preferable for fabric softening compositions to remain stable for cycles of freezing and thawing. Oftentimes, during shipment and storage, fabric softening compositions can be subjected to freezing temperatures. Following one of these freezing and thawing cycles, fabric softening compositions are seen to irreversibly increase in viscosity. If the viscosity increase is too great, then the fabric softening composition can become too viscous to pour and hence be unacceptable to consumers.

WO2010012590 addresses the problem of providing stable fabric softening compositions comprising cationic fabric softening active in the presence of perfume microcapsules. The alleged solution is by addition of an additional cationic surfactant and a nonionic surfactant to the fabric softening composition. However, it does not address the problem of freeze and thaw stability.

The process of the present invention provides for the addition of a silicone emulsion and a polyol to a fabric softening active comprising a multilamellar phase of cationic vesicles. In a third step, a composition comprising perfume microcapsules and specifically, 0.01% to 1.5% by weight of this composition of a water-soluble salt is added. It was surprisingly found that the process of the present invention provides a fabric softening composition comprising perfume microcapsules, that exhibit excellent long-term stability and is stable following freeze and thaw cycles.

### SUMMARY OF THE INVENTION

The present invention is to a process for making a liquid fabric softening composition, comprising the steps of;
a) Providing a first composition comprising a fabric softening active, the fabric softening active comprising a multilamellar phase of cationic vesicles;
b) Adding to, and mixing with the first composition, a silicone emulsion, and a polyol, to produce a second composition, the second composition comprising from 0.0001% to 0.1% by weight of the second composition of a water-soluble salt;
c) Adding to the seqond composition, a third composition, the third composition comprising, 20% to 50% by weight of the third composition of a perfume microcapsule and from 0.01% to 2.5% by weight of the third composition of a water-soluble salt;
d) Mixing the second and third compositions to make a final fabric softening composition.

### DETAILED DESCRIPTION OF THE INVENTION

### Step (a)

The process of the present invention comprises a first process step (a) of providing a first composition comprising a fabric softening active which comprises a multilamellar phase of cationic vesicles.

The cationic surfactant comprises a cationic charged head group and a fatty acid tail group. The cationic surfactant tends to form a lamellar bilayer structure, with the more hydrophobic fatty acid groups associating together. Cationic surfactants are known to form surfactant aggregates, such as cationic vesicles. Due to the head group repulsion of the cationic charged headgroups and processing conditions, the lamellar bilayer curves in, reducing the unfavourable interaction of the hydrophobic fatty acid with water and forms closed lamellar vesicles and multilamellar structures, in which two bilayers are separated by a solvent filled enclosed phase. Average sizes of vesicular structures can vary from an average of 0.1 to 20 μm average particle size (as measured with a Horiba LA-920, 1 min mixing, 600 ppm CaCl₂ in dispersant).

The fabric softening active is preferably present at a concentration from 2% to 20%, preferably from 2% to 12% and most preferably from 3% to 8% by weight of the liquid fabric softening composition.

Preparation of the first composition can be achieved using processes already known in the art. A preferred process for the preparation of the first composition comprises the steps of;
I. mixing and heating of the fabric softener active to form a melt;
II. dispensing the melt in a watery premix, the water containing any adjunct material;
III. cooling the resulting dispersion to below the Krafft temperature of the softener active, wherein the Krafft temperature is meant to be the temperature at which the solubility of the surfactant becomes equal the critical micellar concentration (CMC), the CMC being defined in M. J. Rosen, surfactants and interfacial phenomena, 1988, p. 215.

Preferably, the fabric softener active is selected from the group comprising, diester quaternary ammonium compounds, dialkyl quaternary ammonium compounds, imidazolinium quaternary compounds, cationic starch, sucrose ester-based fabric care materials, and mixtures thereof. A first preferred type of fabric softening active comprises, as the principal active, compounds of the formula

{R₄₋ₘ—N⁺—[(CH₂)ₙ—Y—R¹]ₘ}X⁻ (1)

wherein each R substituent is either hydrogen, short chain C₁-C₆, preferably C₁-C₃ alkyl or hydroxyalkyl group, e.g., methyl, ethyl, propyl, hydroxyethyl, and the like, poly (C₂₋₃ alkoxy), preferably polyethoxy, benzyl, or mixtures thereof; each m is 2 or 3; each n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group, and X⁻ can be any softener-compatible anion, preferably, chloride, bromide, methylsulfate, ethylsulfate, sulfate, and nitrate, more preferably chloride or methyl sulphate.

Non-limiting examples of compound (1) are N,N-bis(stearoyl-oxy-ethyl)N,N-dimethyl ammonium chloride, N,N-bis(tallowoyl-oxy-ethyl)N,N-dimethyl ammonium chloride, N,N-bis(stearoyl-oxy-ethyl)N-(2 hydroxyethyl)N-methyl ammonium methylsulfate.

A second type of preferred fabric softening active has the general formula:

[R₃N⁺CH₂CH(YR¹)(CH₂YR¹)]X⁻

wherein each Y, R, R¹, and X⁻ have the same meanings as before. Such compounds include those having the formula:

[CH₃]₃N⁽⁺⁾[CH₂CH(CH₂O(O)CR¹)O(O)CR¹]Cl⁽⁻⁾ (2)

wherein each R is a methyl or ethyl group and preferably each R¹ is in the range of C₁₅ to C₁₉. As used herein, when the diester is specified, it can include the monoester that is present.

These types of agents and general methods of making them are disclosed in U.S. Pat. No. 4,137,180, Naik et al., issued Jan. 30, 1979. An example of a preferred DEQA (2) is the “propyl” ester quaternary ammonium fabric softener active having the formula 1,2-di(acyloxy)-3-trimethylammoniopropane chloride.

A non-limiting example of compound (2) is 1,2 di (stearoyl-oxy) 3 trimethyl ammoniumpropane chloride.

A third type of preferred fabric softening active has the formula:

[R₄₋ₘ—N⁺—R¹ₘ]X⁻ (3)

wherein each R, R₁, and X⁻ have the same meanings as before.

Non-limiting examples of Compound (3) are dialkylenedimethylammonium salts such as dicanoladimethylammonium chloride, di(hard)tallowedimethylammonium chloride dicanoladimethylammonium methylsulfate. An example of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel Arquad 2HT75.

A fourth type of preferred fabric softening active has the formula:

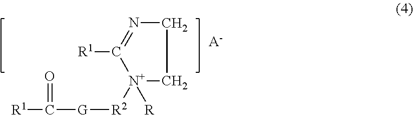

wherein each R, R¹, and A⁻ have the definitions given above; each R² is a C₁₋₆ alkylene group, preferably an ethylene group; and G is an oxygen atom or an —NR— group.

A non-limiting example of Compound (4) is 1-methyl-1-stearoylamidoethyl-2-stearoylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from the Witco Corporation under the trade name Varisoft®.

A fifth type of preferred fabric softening active has the formula:

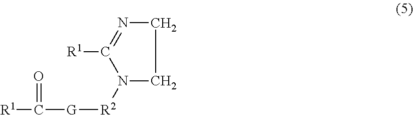

wherein R¹, R² and G are defined as above.

A non-limiting example of Compound (5) is 1-tallowylamidoethyl-2-tallowylimidazoline wherein R¹ is an acyclic aliphatic C₁₅-C₁₇ hydrocarbon group, R² is an ethylene group, and G is a NH group.

A sixth type of preferred fabric softening active are condensation reaction products of fatty acids with dialkylenetriamines in, e.g., a molecular ratio of about 2:1, said reaction products containing compounds of the formula:

R¹—C(O)—NH—R²—NH—R³—NH—C(O)—R¹ (6)

wherein R¹, R² are defined as above, and each R³ is a C₁₋₆ alkylene group, preferably an ethylene group and wherein the reaction products may optionally be quaternized by the additional of an alkylating agent such as dimethyl sulfate. Such quaternized reaction products are described in additional detail in U.S. Pat. No. 5,296,622, issued Mar. 22, 1994 to Uphues et al.

A non-limiting example of Compound (6) is the reaction products of fatty acids with diethylenetriamine in a molecular ratio of about 2:1, said reaction product mixture containing N,N″-dialkyldiethylenetriamine with the formula:

R¹—C(O)—NH—CH₂CH₂—NH—CH₂CH₂—NH—C(O)—R

wherein R¹—C(O) is an alkyl group of a commercially available fatty acid derived from a vegetable or animal source, such as Emersol® 223LL or Emersol® 7021, available from Henkel Corporation, and R² and R³ are divalent ethylene groups.

A seventh type of preferred fabric softening active has the formula:

[R¹—C(O)—NR—R²—N(R)₂—R³—NR—C(O)—R¹]⁺A⁻ (7)

wherein R, R¹, R², R³ and A⁻ are defined as above.

A non-limiting example of Compound (7) is a difatty amidoamine based softener having the formula:

[R¹—C(O)—NH—CH₂CH₂—N(CH₃)(CH₂CH₂OH)—CH₂CH₂—NH—C(O)—R¹]⁺CH₃SO₄⁻

wherein R¹—C(O) is an alkyl group, available commercially from the Witco Corporation e.g. under the trade name Varisoft® 222LT.

An eighth type of preferred fabric softening active are reaction products of fatty acid with hydroxyalkylalkylenediamines in a molecular ratio of about 2:1, said reaction products containing compounds of the formula:

R¹—C(O)—NH—R²—N(R³OH)—C(O)—R¹ (8)

wherein R¹, R² and R³ are defined as above.

An example of Compound (8) is the reaction products of fatty acids with N-2-hydroxyethylethylenediamine in a molecular ratio of about 2:1, said reaction product mixture containing a compound of the formula:

R¹—C(O)—NH—CH₂CH₂—N(CH₂CH₂OH)—C(O)—R

wherein R¹—C(O) is an alkyl group of a commercially available fatty acid derived from a vegetable or animal source, such as Emersol® 223LL or Emersol® 7021, available from Henkel Corporation.

A nineth type of preferred fabric softening active has the formula:

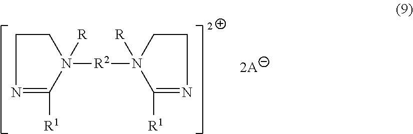

wherein R, R¹, R², and A⁻ are defined as above.

An example of Compound (9) is the diquaternary compound having the formula:

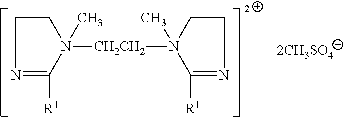

wherein R¹ is derived from fatty acid, and the compound is available from Witco Company.

It will be understood that combinations of softener actives disclosed above are suitable for use in this invention.

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

In one embodiment, the fabric softening active may comprise a cationic starch. The term “cationic starch” is used herein in the broadest sense. In one aspect of the invention, cationic starch refers to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride.

In one embodiment, the fabric softening active may comprise a sucrose ester-based fabric care material. A sucrose ester may be composed of a sucrose moiety having one or more of its hydroxyl groups esterified.

In another embodiment, the fabric softening active may comprise an olyhydroxy material or sugar derivative.

The first composition may comprise adjunct fabric softening actives. These actives may include one or more of the following; clays, fats and/or fatty acids, polyhydroxy amide structures, Pentaerythritol compounds and derivatives thereof and cyclic polyols and/or reduced saccharides.

### Step (b)

The process of the present invention comprises a second step (b) of adding to the first composition, and mixing with the first composition, a silicone emulsion and a polyol, to produce a second composition. The second composition comprises from 0.0001% to 0.1% by weight of the composition of a water-soluble salt.

An emulsion is a mixture of one liquid (the dispersed phase) dispersed in another liquid (the continuous phase). In the context of the present invention, the term ‘silicone emulsion’ also encompasses macroemulsion and microemulsion. A silicone emulsion is understood herein to mean a silicone oil emulsified using a suitable emulsifying agent, this emulsified silicone is then added to a suitable solvent to form the ‘silicone emulsion’. The emulsified silicone is present in the solvent as particles. By “particles”, we also mean droplets or vesicles. In one embodiment the mean particle size of the particles in the silicone emulsion is from 0.01 to 2 micrometer, more preferable from 0.2 to 0.8 micrometer.

In one embodiment the solvent in the silicone emulsion is water. In another embodiment, water, acting as a solvent for the silicone emulsion, can be partially or fully replaced with other suitable solvents. Other suitable solvents include those selected from the group comprising C1-C20 linear, branched, cyclic, saturated and/or unsaturated alcohols with one or more free hydroxy groups; amines, alkanolamines, and mixtures thereof. Preferred solvents are monoalcohols, diols, monoamine derivatives, glycerols, glycols, and mixtures thereof, such as ethanol, propanol, propandiol, monoethanolamin, glycerol, sorbitol, alkylene glycols, polyalkylene glycols, and mixtures thereof. Most preferred solvents are selected from the group comprising 1,2-propandiol, 1.3-propandiol, glycerol, ethylene glycol, diethyleneglycol, and mixtures thereof.

In one embodiment, the emulsifying agent is a non-ionic surfactant.

The silicone oil can be any silicone oil. Preferably, the silicone oil is a polydimethylsiloxane oil, the oil being composed of a homopolymer of linear polydimethylsiloxane obtained by condensation of dimethylsiloxanes and linear or cyclic oligomers of dimethylsiloxane. In one embodiment the polydimethylsiloxane homopolymer is end capped with a trimethyl siloxane unit. In one embodiment the silicone oil is a viscous liquid of a viscosity between 0.0001 m².s⁻¹ (100 centistokes) and 0.1 m².s⁻¹ (100,000 centistokes).

In one embodiment, the emulsified silicone oil is selected from the group comprising non-ionic nitrogen free silicone oils, aminofunctional silicone oils and mixtures thereof.

Preferably the silicone emulsion is selected from the group comprising non-ionic nitrogen free silicone emulsions having the formulae (I), (II), (III), and mixtures thereof:

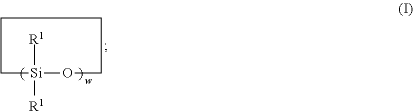

R²—(R¹)₂SiO—[(R¹)₂SiO]ₐ[(R¹)(R²)SiO]_{b}—Si(R¹)₂—R² (II);

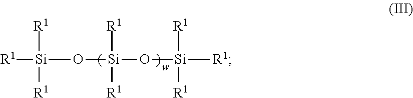

wherein each R¹ is independently selected from the group consisting of linear, branched or cyclic substituted or unsubstituted alkyl groups having from 1 to 20 carbon atoms; linear, branched or cyclic substituted or unsubstituted alkenyl groups having from 2 to 20 carbon atoms; substituted or unsubstituted aryl groups having from 6 to 20 carbon atoms; substituted or unsubstituted alkylaryl, substituted or unsubstituted arylalkyl and substituted or unsubstituted arylalkenyl groups having from 7 to 20 carbon atoms and mixtures thereof; each R² is independently selected from the group consisting of linear, branched or cyclic substituted or unsubstituted alkyl groups having from 1 to 20 carbon atoms; linear, branched or cyclic substituted or unsubstituted alkenyl groups having from 2 to 20 carbon atoms; substituted or unsubstituted aryl groups having from 6 to 20 carbon atoms; substituted or unsubstituted alkylaryl groups, substituted or unsubstituted arylalkyl, substituted or unsubstituted arylalkenyl groups having from 7 to 20 carbon atoms and from a poly(ethyleneoxide/propyleneoxide) copolymer group having the general formula;

—(CH₂)ₙO(C₂H₄O)_{c}(C₃H₆O)_{d}R³ (IV)

polydialkyl silicone, polydimethyl silicone, alkyloxylated silicone, quaternary silicone with at least one R² being a poly(ethyleneoxy/propyleneoxy) copolymer group (ethoxylated silicone, propoxylated silicone, ethoxylated propoxylated silicone emulsions), and each R³ is independently selected from the group consisting of hydrogen, an alkyl having 1 to 4 carbon atoms, an acetyl group, and mixtures thereof, wherein the index w has the value as such that the viscosity of the nitrogen-free silicone polymer of formulae (I) and (III) is between 0.0001 m².s⁻¹ (100 centistokes) and 0.1 m².s⁻¹ (100,000 centistokes); wherein a is from 1 to 50; b is from 1 to 50; n is 1 to 50; total c (for all polyalkyleneoxy side groups) has a value of from 1 to 100; total d is from 0 to 14; total c+d has a value of from 5 to 150.

More preferably, the non-ionic nitrogen free silicone emulsion is selected from the group consisting of linear non-ionic nitrogen-free silicone emulsions having the formulae (II) to (III) as above, wherein R′ is selected from the group consisting of methyl, phenyl, phenylalkyl, and mixtures thereof; wherein R² is selected from the group consisting of methyl, phenyl, phenylalkyl, and mixtures thereof; and from the group having the general formula (IV), as defined above, and mixtures thereof; wherein R³ is defined as above and wherein the index w has a value such that the viscosity of the nitrogen-free silicone emulsion of formula (III) is between 0.0001 m².s⁻¹ (100 centistokes) and 0.1 m².s⁻¹ (100,000 centistokes); a is from 1 to 30, b is from 1 to 30, n is from 3 to 5, total c is from 6 to 100, total d is from 0 to 3, and total c+d is from 7 to 100.

Most preferably, the nitrogen-free silicone emulsion is selected from the group comprising linear non-ionic nitrogen free silicone emulsions having the general formula (III) as above, wherein R′ is methyl, i.e. the silicone emulsion is polydimethyl silicone In this preferred embodiment, wherein the silicone emulsion is polydimethyl silicone, index w has a value such that the polydimethyl silicone has a viscosity between 0.0001 m².s⁻¹ and 0.1 m².s⁻¹, preferably between 0.0003 m².s⁻¹ and 0.06 m².s⁻¹, more preferably between 0.00035 m².s⁻¹ and 0.012 m².s⁻¹.

Where the silicone emulsion is polydimethyl silicone, the polydimethyl silicone has a viscosity between 0.0001 m².s⁻¹ and 0.1 m².s⁻¹, preferably between 0.0003 m².s⁻¹ and 0.06 m².s⁻¹, more preferably between 0.00035 m².s⁻¹ and 0.012 m².s⁻¹.

In one embodiment, the silicone emulsion is a non-ionic nitrogen free silicone oil, preferably, selected from the group comprising polydialkyl silicone, polydimethyl silicone, alkyloxylated silicone, ethoxylated silicone, propoxylated silicone, ethoxylated propoxylated silicone, quaternary silicone or derivatives thereof and mixtures thereof. In a more preferred embodiment, the non-ionic nitrogen free silicone emulsion is selected from the group comprising polydialkyl silicone, polydimethyl silicone and mixtures thereof. In one embodiment, the silicone emulsion is polydimethyl silicone.

In one embodiment of the present invention, the silicone emulsion is an aminofunctional silicone, preferably aminodimethicone.

Aminofunctional silicone emulsions are materials of the formula:

HO[Si(CH₃)₂—O]ₓ{Si(OH)[(CH₂)₃—NH—(CH₂)₂—NH₂]O}_{y}H

wherein x and y are integers which depend on the viscosity of the silicone emulsion. Preferably, the aminofunctional silicone emulsion has a molecular weight such that it exhibits a viscosity of from 0.0005 m².s⁻¹ (500 centistokes) to 0.5 m².s⁻¹ (500,000 centistokes). This material is also known as “aminodimethicone”. Although silicone emulsions with a high number of amine groups, e.g., greater than about 0.5 millimolar equivalent of amine groups can be used, they are not preferred because they can cause fabric yellowing.

The silicone emulsion contains a water-soluble emulsifier, selected from the group of commercially available emulsifiers encompassing cationic, anionic, nonionic or zwitter-ionic emulsifiers. In a preferred embodiment, the emulsifier is a nonionic surfactant.

Premixes of the silicone emulsion can include high internal phase emulsion (“HIPE”). This is achieved by premixing a silicone emulsion, such as polydimethyl silicone, and an emulsifier to create a HIPE, then mixing this HIPE into the composition, thereby achieving good mixing resulting in an homogeneous mixture. Such HIPEs are comprised of at least 65%, alternatively at least 70%, alternatively at least 74%, alternatively at least 80%; alternatively not greater than 95%, by weight of a dispersed phase, wherein the internal phase comprises a silicone emulsion. The internal phase can also be other water insoluble fabric care benefit agents that are not already pre-emulsified. The internal phase is dispersed by using an emulsifying agent. Examples of the emulsifying agent include a surfactant or a surface tension reducing polymer. In one embodiment, the range of the emulsifying agent is from at least 0.1% to 25%, alternatively from 1% to 10%, and alternatively from 2% to 6% by weight of the HIPE. In another embodiment, the emulsifying agent is water soluble and reduces the surface tension of water, at a concentration less than 0.1% by weight of deionized water, to less than 0.0007 N (70 dynes), alternatively less than 0.0006 N (60 dynes), alternatively less than 0.0005 N (50 dynes); alternatively at or greater than 0.0002 N (20 dynes). In another embodiment, the emulsifying agent is at least partially water insoluble.

The silicone emulsion of the present invention is preferably present from 0.3% to 10%, more preferably from 0.5% to 10%, even more preferably from 0.3% to 5%, and most preferably from 0.5% to 3% by weight of the second composition.

Without being bound by theory, it is believed that the presence of the silicone emulsion serves two purposes. Firstly, the silicone emulsion provides a fabric softening benefit, giving a ‘silky feel’ to the fabrics. Secondly, the presence of the silicone emulsion acts to provide stability to the composition following a cycle of freeze and thaw.

In the second process step (b), a polyol is also added to, and mixed with the first composition to produce a second composition. The polyol is preferably selected from the group comprising, glycerol, di-propylene glycol, mono-propylene glycol, pentaerythritol, hexyleneglycol, glucose, sorbitol, sucrose, maltose and combinations thereof. More preferably, the polyol is selected from the group comprising glycerol, di-propylene glycol, mono-propylene glycol and combinations thereof. Most preferably, the polyol is selected from the group comprising, glycerol, mono-propylene glycol and combinations thereof. A most preferred polyol is a polyhydric alcohol. In one embodiment the polyol is present from 0.005% to 20%, preferably from 0.005% to 10%, more preferably from 0.005% to 5%, by weight of the second composition. Without wishing to be bound by theory, the polyol acts to provide stability to the composition following a cycle of freeze and thaw

In one embodiment, in the second process step (b), a non-ionic surfactant is also added to, and mixed with the first composition to produce a second composition. Preferably, the non-ionic alkoxylated surfactant is present from 0.05% to 5%, preferably from 0.1% to 2%, and most preferably from 0.2% to 1% by weight of the second composition. It should also be noted, that in the context of the present invention, non-ionic surfactant can also serve as an emulsifying agent for the silicone emulsion as is described in the previous section. The levels of non-ionic surfactant quoted herein are the overall total levels of non-ionic surfactant in the second composition. Suitable non-ionic surfactants for use herein include the non-ionic alkoxylated surfactants, preferably, alcohol alkoxylate non-ionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary alkyl groups, that contain from about 9 to 15 carbon atoms, more preferably from about 10 to 14 carbon atoms. In one embodiment, the alkoxylated fatty alcohols will also be ethoxylated materials that contain from about 2 to 20 ethylene oxide moieties per molecule, more preferably from about 3 to 18 ethylene oxide moieties per molecule, most preferably 4 to 10 ethylene oxide moieties per molecule. In one embodiment, the non-ionic surfactant is C12/14 alcohol ethoxylate (24E10) with 10 ethoxy units (CAE10). This is commercially available as Slovapol N 247. Without wishing to be bound by theory, the non-ionic surfactant acts to provide stability to the composition following a cycle of freeze and thaw.

In another embodiment, in the second process step (b), one or more adjunct materials may also be added to, and mixed with the first composition to produce a second composition. The adjunct materials are preferably selected from the group comprising, dispersing agents, stabilizers, pH control agents, dyes, odor control agent, solvents, soil release polymers, preservatives, antimicrobial agents, chlorine scavengers, anti-shrinkage agents, anti-oxidants, anti-corrosion agents, as disclosed above, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agent, sun fade inhibitors, insect repellents, anti-allergenic agents, enzymes, flame retardants, water proofing agents, fabric comfort agents, water conditioning agents, shrinkage resistance agents, stretch resistance agents, thickeners/rheology modifiers, chelants, electrolytes and mixtures thereof.

In one embodiment, in the second step (b), silicone emulsion, alkoxylated non-ionic surfactant, a polyol, and/or mixtures thereof are added to, and mixed with the first composition to produce the second composition.

The second composition comprises from 0.0001% to 0.1% by weight of the second composition of a water-soluble salt. In another embodiment, the second composition comprises from 0.001% to 0.1% by weight of the second composition of water-soluble salt.

Mixing and dispersing of the first composition with the ingredients added in step (b) can be achieved with a suitable mixing system, such as IKA-overhead mixers (Euro-ST-PCV type with six bladed “Ruston turbine”), Y-tron Z High shear mixer, static mixers in CLP mode or alternatives.

### Step (c)

In a third step (c), a third composition is added to the second composition. The third composition comprises 20% to 50% by weight of the third composition of a perfume microcapsule and from 0.01 to 1.5% by weight of the third composition of a water-soluble salt, water-soluble salt being defined as water-soluble ionic compounds, composed of dissociated positively charged cations and negatively charged anions. In another embodiment, the third composition comprises from 0.01% to 2% by weight of the third composition of a water-soluble salt. In yet another embodiment, the third composition comprises from 0.01% to 2.5% by weight of the third composition of a water-soluble salt.

It is advantageous to add perfume in the form of encapsulated perfume ingredients to a composition, as the encapsulation of the perfume ingredients allows a controlled and eventually targeted release of the perfume ingredients. Perfume ingredients are the individual chemical compounds that are used to make a perfume composition. A perfume composition comprises one or more perfume ingredients, the choice of type and number of ingredients being dependent upon the final desired scent. The present invention comprises perfume microcapsules. It is well known to those skilled in the art, that perfume microcapsules release perfume ingredients during handling of fabrics and during the in-wear process, providing improved longer lasting freshness on fabrics, as compared to the addition of neat perfume alone. The release of the perfume ingredients is triggered by mechanical stress breaking the capsule wall and allowing the diffusion of the encapsulated perfume ingredient.

A perfume microcapsule comprises a capsule surrounding a core, that core comprising perfume ingredients. The capsule can be made of a number of materials, but most preferred is cross-linked melamine formaldehyde. The capsule wall material may comprise a suitable resin including the reaction product of an aldehyde and an amine, suitable aldehydes include, formaldehyde. Suitable amines can include those selected from the group comprising melamine, urea, benzoguanamine, glycoluril, and mixtures thereof. Suitable melamines can include those selected from the group comprising methylol melamine, methylated methylol melamine, imino melamine and mixtures thereof. Suitable ureas can include those selected from the group comprising dimethylol urea, methylated dimethylol urea, urea-resorcinol, and mixtures thereof.

In the context of the present invention, any suitable perfume ingredient may be used. Those skilled in the art will recognise suitable compatible perfume ingredients for use in the perfume microcapsules, and will know how to select combinations of ingredients to achieve desired scents.

In one aspect, at least 75%, 85% or even 90% of said perfume microcapsules may have a particle size of from about 1 microns to about 80 microns, about 5 microns to 60 microns, from about 10 microns to about 50 microns, or even from about 15 microns to about 40 microns.

At least 75%, 85% or even 90% of said perfume microcapsules may have a particle wall thickness of from about 60 nm to about 250 nm, from about 80 nm to about 180 nm, or even from about 100 nm to about 160 nm.

In one embodiment, the water-soluble salt comprises cations selected from the group comprising Sodium, Potassium, Beryllium, Magnesium, Calcium, Strontium, Barium, Scandium, Titan, Iron, Aluminium, Zinc, Germanium, Tin, Ammonium and comprises anions selected from the group comprising Fluorine, Chlorine, Bromine, Iodine, Acetate, Carbonate, Citrate, hydroxide, Nitrate, phosphate, formate, sulfate and benzoate. In another embodiment, the water-soluble salt in the third composition is magnesium chloride. In one embodiment, the third composition comprises 0.01 to 1.5% by weight of the third composition of magnesium chloride. In another embodiment, the third composition comprises 0.01 to 2% by weight of the third composition of magnesium chloride. In yet another embodiment, the third composition comprises 0.01 to 2.5% by weight of the third composition of magnesium chloride.

In another embodiment, the third composition may comprise one or more of the following optional ingredients: perfumes (non-encapsulated), other encapsulated perfumes, dispersing agents, stabilizers, pH control agents, colorants, brighteners, dyes, odor control agent, pro-perfumes, cyclodextrin, solvents, soil release polymers, preservatives, antimicrobial agents, chlorine scavengers, anti-shrinkage agents, fabric crisping agents, spotting agents, anti-oxidants, anti-corrosion agents, formaldehyde scavengers as disclosed above, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, thickeners/rheology modifiers, chelants, electrolytes and mixtures thereof.

### Step (d)

In a fourth step (d), the second composition and the third composition are mixed together. Mixing and dispersing of the second composition with the third composition can be achieved with a suitable mixing system, such as Ytron mill, Y-tron Z High shear mixer, Ultra-turrax T25 or alternatives. Mixing of the second and third compositions, results in the production of the final fabric softening composition.

### Stability Data

When left over time at ambient or at elevated temperatures, liquid fabric softening compositions tend to exhibit loss of structural integrity, manifesting itself as phase separation. Phase separation can usually be seen visually as a distinct split of the liquid product into a top phase and a less turbid bottom phase. Following phase separation, the product will often not re-mix, and/or will exhibit lowered performance. The longer the product is left, the more likely it is to phase separate. Also, the higher the temperature, the sooner the product tends to phase separate. The phase separation over time impacts on the storage life of the product. This limitation is most acute in geographies that require longer shipping periods from plant to the consumer home. In some cases a product would need to maintain structural integrity for up 35 weeks, preferably up to 40 weeks, more preferably up to 50 weeks, when stored at ambient temperature (includes shipment and storage at consumer homes). Shipment, especially in summertime, in closed trucks or containers can lead to temporary exposure of products to relatively high temperatures, possibly even up to 35° C. Also, during storage in warehouses, supermarkets or consumer homes, the product is typically exposed to temperatures in the range of 16° C. to 35° C. for extended periods of time.

A cycle of freezing and thawing of a liquid fabric softening composition tends to result in an increase in the viscosity of the product. This increase in viscosity affects its pourability and dispersibility. Each successive cycle of freezing and thawing, results in an incremental increase in the product viscosity. Therefore, there is a need to minimize the viscosity increase following successive freeze and thaw cycles. Without wishing to be bound by theory, it is believed that following a freeze and thaw cycle, the cationic vesicles tend to rupture, and reform platelet or sheet like structures. The presence of these sheet-like structures causes the viscosity of the fabric softening composition to increase. It is believed that fabric softening compositions of the present invention retain more of the cationic vesicular structures following a freeze and thaw cycles.

Products exhibiting a viscosity of lower than 0.5 kg m⁻¹ s⁻¹ as measured using a Brookfield LV-DV-E viscometer (serial no. E3987 or E7085), spindle 2, at 60 rpm and ambient temperature of 20° C. were shown to have consumer accepted pourability profiles.

Therefore, products need to be able to show a consumer acceptable viscosity following 2, preferably 4 successive cycles of freeze and thaw, and also structural integrity when stored at 35° C. for up to 30 days.

### Sample Preparation:

150 g of liquid fabric softening composition were prepared using the process described in Claim 1.
A first composition was prepared comprising 8% by weight of the first composition of a tallow-comprising Methyl-DiEthanolAmine dialkyl esterquat fabric softening active;
1% of a PDMS emulsion available from Wacker, a heated mixture (40-43° C.), 7% Glycerol and 0.8% of a non-ionic alkoxylated surfactant (CAE10), preservative, pH control agents, 0.008% MP10 Antifoam, Liquitint Dyesolution, Perfume and Rheovis CDE structurant, were added to the first composition and mixed together using an IKA-overhead mixer (EURO-St-PCV (Id: 01.307227), followed by dispersion using an Ytron-Mill to produce a second composition;
0.83% of a third composition was added to the second composition. The third composition comprised 30% by weight of the third composition of perfume microcapsules and levels of MgCl₂ that varied between 0.01% and 1.9% by weight of the third composition;
The second and third composition were mixed together using an IKA-overhead mixer (EURO-St-PCV (Id: 01.307227), followed by dispersion using an Ytron-Mill (Type ZL-50-FC 2/0.1, Id.: 960 7464), to produce the final fabric softening composition.

The final fabric softening compositions were then aliquoted into glass jars. All samples were equilibrated for 24 hours at 20° C., commonly referred to as ambient or room-temperature.

### Phase Separation

150 g of fabric softening composition as described above was aliquoted into glass jars and stored at 35° C. for 90 days. Phase separation was assessed by visual checks at time intervals of 1, 7, 14, 21, 30, 60, and 90 days. The assessment of phase separation was conducted by tilting the sample jar by an angle of 35-45° and checking visually for the formation of a second phase.

### Freeze Thaw Cycling:

Samples were transferred to −18° C. for 24 h, followed by a viscosity measurement after 24 h at 20° C. This is referred to as one cycle of freeze and thaw. One more successive cycle was then conducted on the same sample resulting in 2 cycles in total for each sample. The samples were assessed as to whether they were still pourable. To do this, the viscosity of the composition was assessed using a Brookfield LV-DV-E viscometer (serial no. E3987 or E7085), spindle 2, at 60 rpm and a sample temperature of 20° C. Viscosity readings in cps [mPa*s or kg*m⁻¹s⁻¹] were taken after the viscosity reading stabilised on the viscometer digital readout. A composition with a viscosity of less than 0.5 kg m⁻¹ s⁻¹ were classed as pourable.

Table 1 shows varying levels of MgCl₂ in the third composition, and the impact this has upon long term storage at 35° C. and on viscosity following 2 successive freeze and thaw cycles. As can be seen, as the concentration of MgCl₂ in the third composition decreases, the time taken at 35° C. before phase separation is longer. Following two successive freeze and thaw cycles, the fabric softening composition allows remains pourable.

TABLE 1

| | Amount of 3^{rd} | | | | | | | | | | | |
|---|---|---|---|---|---|---|---|---|---|---|---|---|
| | composition | Pourable | | | | | | | | | | |
| % MgCl₂ | added by weight | after 2 | | | | | | | | | | |
| in 3^{rd} | of overall final | freeze and | Weeks (PS = Phase separation) | | | | | | | | | |
| composition | composition | thaw cycles | 0 | 7 | 14 | 21 | 28 | 35 | 42 | 49 | 56 | 63 |
| 0.00 | 0.83 | yes | Ok | Ok | Ok | Ok | Ok | Ok | Ok | Ok | Ok | PS |
| 0.50 | 0.83 | yes | Ok | Ok | Ok | Ok | Ok | Ok | Ok | Ok | PS | PS |
| 1.00 | 0.83 | yes | Ok | Ok | Ok | Ok | Ok | Ok | PS | PS | PS | PS |
| 1.9 | 0.83 | yes | Ok | Ok | Ok | Ok | Ok | Ok | PS | PS | PS | PS |

### EXAMPLES

Table 2 details non-limiting examples of compositions of the present invention. Percentages are expressed as percentage by weight of the composition.

TABLE 2

| INGREDIENTS | Examples | | | | | | | |
|---|---|---|---|---|---|---|---|---|
| Composition I | I | II | III | IV | V | VI | VII | VIII |
| Fabric softening | 7.10% | 7.12% | 7.15% | 3.48 | 3.47 | 6.99 | 7.04 | 7.16% |
| active ^{a} | | | | | | | | |
| Preservative ^{b} | 0.0075% | 0.0075% | 0.0075% | 0.0075% | 0.0075% | 0.0075% | 0.0075% | 0.0075% |
| Calcium chloride ^{c} | 0.005% | 0.005% | 0.005% | 0.005% | 0.005% | 0.005% | 0.005% | 0.005% |
| Formic acid ^{d} | 0.025% | 0.025% | 0.025% | 0.025% | 0.025% | 0.025% | 0.025% | 0.025% |
| SodiumHEDP ^{e} | 0.0071% | 0.0071% | 0.0071% | — | — | 0.0071% | 0.0071% | 0.0071% |
| Demin water | Balance | Balance | Balance | Balance | Balance | Balance | Balance | Balance |
| MP10 Antifoam ^{f} | 0.008% | 0.008% | 0.008% | 0.008% | 0.008% | 0.008% | 0.008% | 0.008% |
| Glycerol ^{g} | 7.00% | 7.00% | 7.00% | 4.5% | 4.5% | 9% | 9% | 7% |
| CAE10 ^{h} | 0.80% | 1.20% | 0.80% | 0.40% | 0.40% | 1.2% | 0.8% | 0.8% |
| Liquitint Violet 288 ⁱ | 0.0012.5% | 0.0012.5% | 0.0012.5% | 0.0012.5% | 0.0012.5% | 0.0012.5% | 00012.5% | 0.0012.5% |
| Liquitint PR ^{j} | 0.0002.5% | 0.0002.5% | 0.0002.5% | 0.0002.5% | 0.0002.5% | 0.0002.5% | 0 0002.5% | 0.0002.5% |
| Perfume ^{k} | 0.64% | 0.64% | 0.64% | 0.64% | 0.64% | 0.64% | 0.64% | 0.58 |
| Perfume microcapsule | 1.73% | 1.13% | 1.13% | 0.53% | 0.71% | 0.53% | 0.53% | — |
| slurry ^{l} | | | | | | | | |
| Perfume microcapsule | — | — | — | — | — | — | — | 0.83% |
| slurry ^{m} | | | | | | | | |
| Silicone emulsion ⁿ | 1% | 1% | 1% | 3% | 3% | 1% | 1% | 0.72% |
| Structurant ^{o} | 0.1625% | 0.075% | 0.1625% | 0.25% | 0.35% | 0.25% | 0.075 | 0.075 |

^{a} N,N-di(tallowoyloxyethyl)-N,N-dimethylammonium chloride, commercially available by Evonic Goldschmidt Cooperation
^{b} Proxel, 1,2-Benzisothiazol-3(2H)-one, Arch chemicals
^{c} CaCl₂ solution, 2.5% solids
^{d} Formic Acid, BASF Ludwigshafen
^{e} Sodium HEDP, 20% HEDP monosodium salt solution, Rhodia
^{f} MP10 Antifoam, Dow Corning
^{g} Glycerol, Oleon Nv Maatschappeliijke Zetel (Ertvelde BE)
^{h} CAE10, Non ionic surfactant - C12/14 Alcohol Ethoxylate, Slovapol N 247 supplied by (Zavod Syntanolov)
ⁱ Liquitint Violet 288, Milliken & Co (Inman US)
^{j} Liquitint PR, Milliken & Co (Inman US)
^{k} Perfume, P&G Worms
^{l} Perfume Microcapsule slurry with 28.3% Encapsulated perfume ingredients in Perfume microcapsules supplied by Appelton Papers Inc. in 1% MgCl₂ slurry.
^{m} Perfume Microcapsule slurry with 30% encapsulated perfume ingredients and differing MgCl₂ levels in slurry, slurries supplied by Appelton Papers Inc.
ⁿ Silicone emulsion, available under the trade name E3500 supplied by Wacker, Burghausen Germany
^{o} Structurant, Rheovis CDE, CIBA Speciality Chemicals

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a liquid fabric softening composition, comprising the steps of;
a) Providing a first composition comprising a fabric softening active, the fabric softening active comprising a multilamellar phase of cationic vesicles;
b) Adding to, and mixing with the first composition, a silicone emulsion, and a polyol, to produce a second composition, the second composition comprising from about 0.0001% to about 0.1% by weight of the second composition of a water-soluble salt;
c) Adding to the second composition, a third composition, the third composition comprising, about 20% to about 50% by weight of the third composition of a perfume microcapsule and from about 0.01% to about 2.5% by weight of the third composition of a water-soluble salt;
d) Mixing the second and third compositions to make a final fabric softening composition.

2. The process of claim 1, wherein the second composition comprises from about 0.001% to about 0.1% by weight of the second composition of water-soluble salt.

3. The process of claim 1, wherein the water-soluble salt of the third composition comprises cations selected from the group comprising Sodium, Potassium, Beryllium, Magnesium, Calcium, Strontium, Barium, Scandium, Titan, Iron, Aluminium, Zinc, Germanium, Tin, Ammonium and comprises anions selected from the group comprising Fluorine, Chlorine, Bromine, Iodine, Acetate, Carbonate, Citrate, hydroxide, Nitrate, phosphate, formate, sulfate and benzoate.

4. The process of claim 1, wherein the cationic fabric softening active is present at a concentration from about 2% to about 20%, by weight of the first composition.

5. The process of claim 4, wherein the cationic fabric softening active is present at a concentration from about 2% to about 12%, by weight of the first composition.

6. The process of claim 1, wherein the fabric softening active is a quaternary ammonium compound.

7. The process of claim 6, wherein the fabric softening active is selected from the group comprising N,N-bis(stearoyl-oxy-ethyl)dimethyl ammonium chloride and N,N-bis(tallowoyl-oxy-ethyl)dimethyl ammonium chloride, and mixtures thereof.

8. The process of claim 1, wherein the second composition comprises from about 0.3% to about 10%, by weight of the second composition, of the silicone emulsion.

9. The process of claim 8, wherein the second composition comprises from about 0.5% to about 10%, by weight of the second composition, of the silicone emulsion.

10. The process of claim 9, wherein the second composition comprises from about 0.3% to about 5%, by weight of the second composition, of the silicone emulsion.

11. The process of claim 10, wherein the second composition comprises from about 0.5% to about 3%, by weight of the second composition, of the silicone emulsion.

12. The process of claim 1, wherein the polyol is present from about 0.005% to about 20%, by weight of the second composition.

13. The process of claim 12, wherein the polyol is present from about 0.005% to about 10%, by weight of the second composition.

14. The process of claim 1, wherein the polyol is glycerol.

15. The process of claim 1, wherein in step (b), a non-ionic surfactant is also added to, and mixed with the first composition.

16. The process of claim 15, wherein the non-ionic surfactant is a non-ionic alkoxylated surfactant.

17. The process of claim 16, wherein the non-ionic surfactant is C12/14 alcohol ethoxylate (24E10) with 10 ethoxy units.

18. The process of claim 15, wherein the non-ionic surfactant is present from about 0.05% to about 5%, by weight of the second composition.

19. The process of claim 18, wherein the non-ionic surfactant is present from about 0.1% to about 2%, by weight of the second composition.

20. The process of claim 19, wherein the non-ionic surfactant is present from about 0.2% to about 1%, by weight of the second composition.
